(19) United States
(12) Patent Application Publication
(10) Pub. No.: US 2015/0162122 A1
(43) Pub. Date: Jun. 11, 2015

(54) SURFACE MOUNT DEVICE TYPE INDUCTOR AND METHOD OF MANUFACTURING THE SAME

(71) Applicants: Sun-Ki Kim, Gunpo-si (KR); JOINSET CO., LTD., Ansan-si (KR)

(72) Inventors: Kee-Han Park, Ansan-si (KR); Jae-Gil Choi, Ansan-si (KR); Sun-Ki Kim, Gunpo-si (KR)

(73) Assignees: JOINSET CO., LTD.; Sun-Ki Kim

(21) Appl. No.: 14/560,047

(22) Filed: Dec. 4, 2014

(30) Foreign Application Priority Data
Dec. 9, 2013 (KR) 10-2013-0152679
Aug. 25, 2014 (KR) 10-2014-0110612

(51) Int. Cl. H01F 27/22; H01F 41/02; H01F 27/24; H01F 27/29; H01F 27/28

(52) U.S. Cl. CPC H01F 27/22; H01F 27/292; H01F 27/28; H01F 27/24; H01F 41/02

(57) ABSTRACT

Provided is a surface-mount device (SMD) type inductor reducing electric contact resistance between external electrodes and a metal core of an insulating coil. The inductor includes a core formed of magnetic material, an insulating coil wound on an outer surface of the core, a mold body containing the core and the insulating coil to be embedded therein, ends of the insulating coil protruding respectively from both sides of the mold body, which are opposite to each other, the mold body formed of soft magnetic metal compact using soft magnetic metal powder, and external electrodes formed on the both sides of the mold body and electrically connected to a metal core of the protruding ends of the insulating coil. Herein, the protruding ends of the insulating coil are partially removed by physical force to expose the metal core and the external electrodes are electrically connected to the exposed metal core.

### REFERENCE TO RELATED APPLICATIONS

This application claims the priority benefit of Korean Patent Application No. 10-2013-0152679, filed on Dec. 9, 2013, and Korean Patent Application No. 10-2014-0110612, filed on Aug. 25, 2014, the entire contents of which are incorporated herein by reference.

### FIELD OF THE INVENTION

One or more embodiments of the present invention relate to a surface-mount device (SMD) type inductor reducing electric contact resistance between an external electrode and an insulating coil and improving the reliability of electric contact to increase an inductance value and allow high current to flow, and more particularly, to a method of economically and efficiently manufacturing the same.

### BACKGROUND OF THE INVENTION

As electric components formed of ceramic materials, there are capacitors, inductors, piezoelectric devices, varistors, and thermisters.

Among these ceramic electric components, together with resistors and capacitors, inductors are one of significant passive elements forming electronic circuits, which are used to reduce noise or to form LC resonance circuits.

Inductors may be classified into several types such as a multilayer type, a wire wound type, and a thin film type, which differ in an applicable range or a manufacturing method thereof.

Generally, wire wound inductors may have higher accuracy and inductance and may more increase allowable currents than multilayer inductors.

Among these, surface-mounted wire wound inductors, for example, may be formed by allowing an internal magnetic core to be wound with an insulating coil thereon and to be embedded in an external magnetic mold body and attaching a metal core wire of the insulating coil to an external electrode formed on an outer surface of the mold body through spot welding.

The insulating coil is generally formed of enameled wire. Since a cross-sectional area of the metal core wire of the insulating coil exposed outwards is small, an area in electric contact with the external electrode is small. As a result thereof, electric contact resistance increases and the reliability of electric contact decreases.

Also, the magnetic core and the mold body include semiconductivity. When an insulator forming the insulating coil gets torn or damaged while winding the insulating coil on the magnetic core or molding the molding body to embed the magnetic core in the mold body, a current flowing through the metal core wire of the insulating coil leaks.

Particularly, when a high current leaks to the mold body, which is semiconductive, plating may spread over a surface of the mold body during electroplating to form a plating layer on an outer surface of the external electrode and a leaking current itself may have a bad effect on inductor property.

### SUMMARY OF THE INVENTION

One or more embodiments of the present invention include a surface-mount device (SMD) type inductor capable of reducing electric contact resistance between a metal core of an internal insulating coil and an external electrode and providing reliable electric contact.

One or more embodiments of the present invention include an SMD type inductor having a high inductance value.

One or more embodiments of the present invention include an SMD type inductor capable of allowing a high current to flow.

One or more embodiments of the present invention include an SMD type inductor capable of preventing a leaking current and being easily plated.

One or more embodiments of the present invention include an SMD type inductor capable of preventing a leaking current, although the insulation of an insulating coil gets damaged.

One or more embodiments of the present invention include a method of economically and efficiently manufacturing the SMD type inductors.

Additional aspects will be set forth in part in the description which follows and, in part, will be apparent from the description, or may be learned by practice of the presented embodiments.

According to one or more embodiments of the present invention, an SMD type inductor includes a core formed of magnetic material, an insulating coil wound on an outer surface of the core, a mold body containing the core and the insulating coil to be embedded therein, ends of the insulating coil protruding respectively from both sides of the mold body, which are opposite to each other, the mold body formed of soft magnetic metal compact using soft magnetic metal powder, and external electrodes formed on the both sides of the mold body and electrically connected to a metal core of the protruding ends of the insulating coil, in which the protruding ends of the insulating coil are partially removed by physical force to expose the metal core and the external electrodes are electrically connected to the exposed metal core.

According to one or more embodiments of the present invention, a method of manufacturing an SMD type inductor includes forming a core by pressing powder of magnetic material, burning or thermally curing the core, winding an insulating coil on an outer surface of the core, forming a mold body by putting the core wound with the insulating coil into a mold jig and applying soft magnetic metal powder thereto to embed the insulating coil and the core therein and to allow ends of the insulating coil to protrude, polishing or abrading the mold body, and forming external electrodes on sides of the mold body, which are opposite to each other, to be electrically connected to a metal core of the ends of the insulating coil, in which the ends of the insulating coil are partially removed by one of the polishing and abrading to expose the metal core of the ends of the insulating coil and the external electrodes are electrically connected to the exposed metal core.

The core may include one of a ferrite sintered body formed by pressing and burning ferrite powder having magnetic properties and a soft magnetic metal compact formed by compacting and thermally curing soft magnetic metal powder having magnetic properties.

The ferrite powder and the soft magnetic metal powder may be coated or may include heat-resistant polymer resin.

The insulating coil may be formed by coating the metal core with insulating polymer resin having thermal resistance, and the insulating polymer resin may be removed by the physical force, thereby exposing the metal core.

The external electrodes may be formed by curing electroconductive epoxy paste adhesives and the electroconductive epoxy paste adhesives may be sequentially coated with nickel and tin thereon.

A heat-resistant insulating coating layer may be formed on an outer surface of the mold body, and the heat-resistant insulating coating layer may include one of glass and heat-resistant polymer resin.

The physical force may be one of polishing and abrasion, which closely attaches the ends of the insulating coil to the mold body and bents, elongates, and compress the metal core to be ductilely deformed.

The metal core may be exposed as much as the protruding ends of the insulating coil due to the physical fore and a contact area with the external electrode increases, thereby reducing electric contact resistance of the metal core and increasing the reliability of electric contact.

The mold body may be thermally cured and the mechanical strength of the mold body increases due to the thermal curing.

Tips, in which the ends of the insulating coil are embedded, may protrude from the sides of the mold body, and the tips may be cut off from the mold body, thereby allowing the ends of the insulating coil to protrude.

An outer surface of the mold body may be polished using a ball-mill or abraded using an abrasive roll.

The mold body may be formed by one of compacting soft magnetic metal powder coated with polymer resin, potting liquid polymer resin including soft magnetic metal powder, and injection-molding pellets including soft magnetic metal powder.

### BRIEF DESCRIPTION OF THE DRAWINGS

These and/or other aspects will become apparent and more readily appreciated from the following description of the embodiments, taken in conjunction with the accompanying drawings of which:

FIG. 1 is an outside view of a surface-mount device (SMD) type inductor according to one or more embodiments of the present invention;

FIG. 2 is a cross-sectional view illustrating a part taken along a line 2-2 shown in FIG. 1;

FIG. 3 is a flowchart illustrating a method of manufacturing the SMD type inductor according to one or more embodiments of the present invention; and

FIGS. 4(A) to 4(D) illustrate a process of manufacturing the SMD type inductor.

### DETAILED DESCRIPTION OF THE INVENTION

Hereinafter, one or more embodiments of the present invention will be described in detail with reference to the attached drawings.

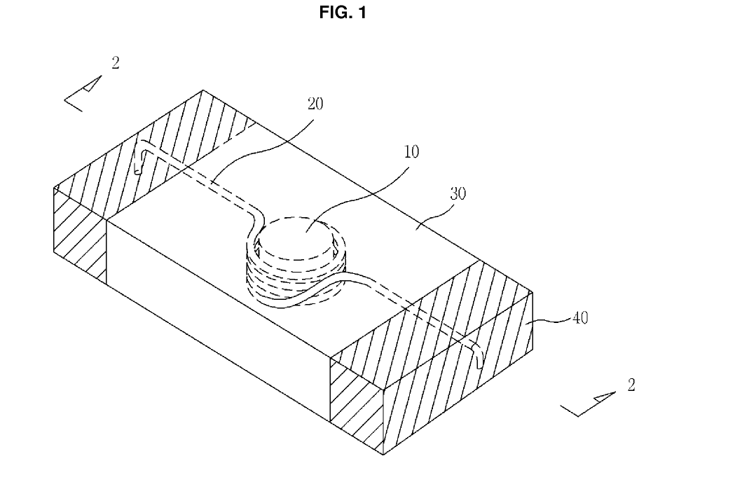

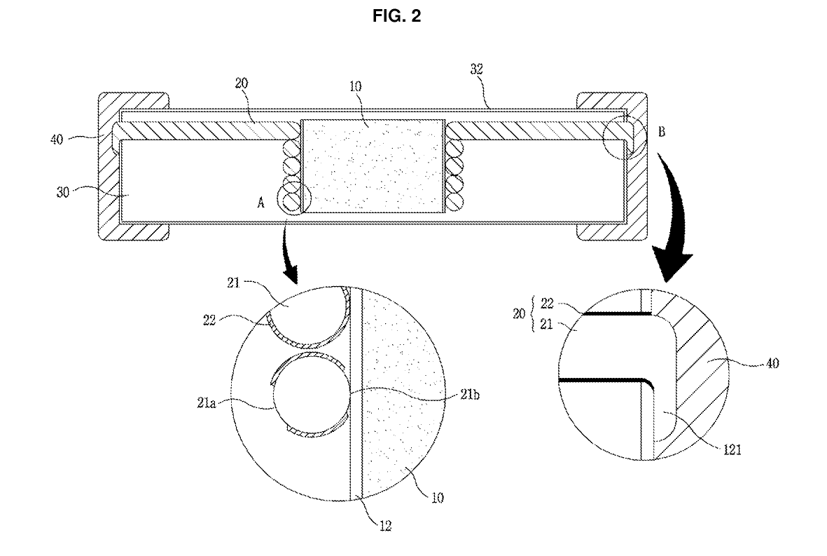

FIG. 1 is an outside view illustrating a surface-mount device (SMD) type inductor according to one or more embodiments of the present invention, and FIG. 2 is a cross-sectional view illustrating a part taken along a line 2-2 shown in FIG. 1.

Referring to FIGS. 1 and 2, the SMD type inductor may be a power inductor and includes a magnetic core 10, an insulating coil 20 wound on an outer surface of the core 10, a magnetic mold body 30 containing the core 10 and the insulating coil 20, and external electrodes 40 formed on sides of to the mold body 30, opposite to each other, to be electrically connected to the insulating coil 10, respectively.

Hereinafter, respective elements will be described in detail.

The core 10 may be formed of a soft magnetic metal compact having magnetic properties or a ferrite sintered body having magnetic properties. The soft magnetic metal compact may be formed by compacting and thermally curing metal powder having soft magnetic properties. The ferrite sintered body may be formed by pressing and burning ferrite powder having magnetic properties.

Herein, to allow the soft magnetic metal compact to have enough mechanical strength, the soft magnetic metal power may be thermally cured at a temperature of about 160° C.

Finally, the ferrite sintered body and the soft magnetic metal compact may have semiconductivity of from about 104 to about 109 Ω.

When the core 10 is the ferrite sintered body, since the ferrite sintered body has generally higher magnetic permeability than the soft magnetic metal compact manufactured using soft magnetic metal powder, the inductor may have a higher inductance value. As a result thereof, compare with a case of applying the soft magnetic metal compact to the core 10, although the insulating coil 20 is less wound on the core 10, the same inductance value may be provided. Similarly, when using the ferrite sintered body as the core 10 and providing the same inductance value, since the inductor may be less wound with the insulating coil 20, a metal core 21 may have a large diameter, thereby allowing high currents to flow.

Herein, the soft magnetic metal powder having magnetic properties and the ferrite powder having magnetic properties are generally well-known magnetic materials. For example, as the soft magnetic metal powder, there may be permalloy metal power, amorphous metal powder, and sendust powder. As the ferrite powder, there may be Ni—Mn powder, etc.

Also, the ferrite powder and the soft magnetic metal powder may be coated with or include heat-resistant polymer resin capable of satisfying a soldering condition, such as epoxy resin and silicone rubber.

As an example, an outer surface of the core 10 may be coated with insulating glass or polymer resin having thermal resistance such as epoxy resin or parylene resin, thereby forming an insulating coating layer 12.

Particularly, when being the soft magnetic metal compact, the core 10 is coated with heat-resistant polymer resin having thermal resistance capable of being durable at a soldering temperature.

According to a structure described above, as shown in FIG. 2, although a part of an insulating coating forming the insulating coil 20, in contact with the core 10, gets torn and a metal core 21b exposed through the part is in contact with the core 10 to allow currents flowing through inside the insulating coil 20 to leak, a leaking current is prevented from flowing through the semiconductive core 10 due to the insulating coating layer 12.

In addition to parylene resin, β-polyvinylidene fluoride or polyimide may be used.

The insulating coil 20 designates wound wire having a structure, in which the electroconductive metal core 21 is surrounded with an insulating coating 22 and may be formed of enameled wire having thermal resistance capable of being durable at a soldering temperature.

As well known, the enameled wire is insulating wire with thin-coated with insulating polymer resin having thermal resistance on a surface thereof. The enameled wire has a thin insulating coating layer while having high insulating properties and being not well denatured by chemicals.

In the embodiment, the insulating coil 20 may be, for example, the enameled wire but not limited thereto.

Referring to FIG. 2, the insulating coil 20 may include the metal core 21 and the insulating coating 22 surrounding the metal core 21 and may have a diameter of from about 0.03 mm to about 0.3 mm.

The metal core 21 functioning as a path of electricity may be formed of copper or a copper alloy, which well elongates, that is, has high ductility and has excellent electric conductivity.

Since being used to maintain electrical insulation between the metal cores 21, the insulating coating 22 includes not only electrical insulation but also thermal resistance capable of being durable at a soldering temperature. As the insulating coating 22, for example, polyester resin or polyimide resin may be used.

Both ends of the insulating coil 20 pass through the soft magnetic mold body 30 and protrude outwards in such a way that the metal core 21 is electrically connected to the external electrode 40, respectively, as follows.

The insulating coil 20 protruding outwards from the mold body 30 is removed with the insulating coating 22 by external physical force, for example, polishing or abrading, thereby exposing the metal core 21. As a result thereof, the metal core 21 is exposed as a length of the protruding insulating coil 20 in such a way that an area of the metal core 21 in contact with the external electrode 40.

Additionally, when the metal core 21 is bent by physical force to be closely attached to the mold body 30 or elongates, thereby increasing a surface area.

Accordingly, since the external electrode 40 gets in electric contact with a metal core 121 over a larger area, electric contact resistance may decrease and reliable electric contact may be provided.

The mold body 30 surrounds the core 10 and the insulating coil 20 to be embedded therein.

The mold body 30 may be the soft magnetic metal compact formed by compacting or molding soft magnetic metal powder, which may be manufactured as follows.

1) Soft magnetic metal powder coated with polymer resin having thermal resistance such as epoxy resin and silicone rubber is compacted and selectively cured.

2) Pellets soft magnetic metal powder coated with polymer resin are injected into a mold to be injection-molded and cured.

3) Soft magnetic metal powder is uniformly scatted into liquid polymer resin and mixed and then potted into a mold to be cured.

Curing, which is thermal curing, may be performed at a temperature from about 150° C. to about 250° C. for from about 10 minutes to about 2 hours in such a way that the mold body 30 has full mechanical strength.

The mold body 30 has semiconductivity with from about 104 to about 109 Ω.

An outer surface of the mold body 30 of the mold body 30 formed of soft magnetic metal compact may be coated with the polymer resin used for the insulating coating layer 12 of the core 10, thereby forming an insulating coating layer 32.

According to the described above, as shown in FIG. 2, although an insulating coating forming the insulating coil 20 gets torn and a metal core 21a is exposed outwards in such a way that currents flowing through the insulating coil 20 flow through the mold body 30, the currents are prevented from leaking out of the mold body 30 by the insulating coating layer 32.

Also, although the metal core 21b is exposed outwards in such a way that the currents flowing through the insulating coil 20 flow through the core 10 and the mold body 30, the currents are prevented from leaking out of the mold body 30 by the insulating coating layer 32.

Accordingly, when performing an electroplating process to form a plating layer on the outer surface of the external electrode 40, plating may be prevented from spreading over the surface of the mold body 30 and properties of the inductor may be prevented from being deteriorated due to a leaking current.

The insulating coating layer 32 may be formed to enclose the whole outer surface of the mold body 30. A thickness of the insulating coating layer 32 formed on a top and a bottom of the mold body 30 may be greater than that of the insulating coating layer 32 on sides of the mold body 30, from which the insulating coil 20 protrudes. That is, the sides, from which the insulating coil 20 protrudes, are polished or abraded to remove the insulating coating 22 of the insulating coil 20. Herein, the insulating coating layer 32 is partially removed.

The insulating coating layer 32 formed on the mold body 30 has thermal resistance capable of being durable at a soldering temperature, similarly to the insulating coating layer 12 of the core 10.

As polymer resin used for the insulating coating layer 32, similar to the core 10, there are β-polyvinylidene fluoride and polyimide in addition to epoxy resin or parylene.

Preferably, the external electrode 40 may be formed by plating electroconductive epoxy paste adhesives formed by mixing metal powder such as silver with epoxy adhesives with nickel and tin.

For example, an outermost layer of the external electrodes 0 formed on the both sides of the mold body 30 may be a tin-coating layer.

The both sides of the mold body 30 are coated with the electroconductive epoxy paste adhesives through dipping and then cured at a temperature of about 250° C. to adhere the mold body 30 to the metal core 121 of the insulating coil 20, thereby electrically connecting the external electrode 40 to the metal core 121 to have reliability.

Herein, smaller electric contact resistance between the external electrode 40 and the metal core 121 are better and the external electrode 40 and the metal core 121 may be reliably electrically connected to each other, although a shock is given thereto. In other words, a larger area of the metal core 121 is to be availably in contact with the external electrode to reduce electric contact resistance and to be reliably electrically connected to each other.

As described above, since the metal core 121 of the insulating coil 20 protruding from the both sides of the mold body 30, respectively, is in directly electric contact with conductive epoxy forming the external electrode 40, the metal core 121 is electrically connected to the conductive epoxy due to curing of the conductive epoxy without an additional connecting element such as spot welding, thereby being easily manufactured at lower manufacturing costs.

Also, since the metal core 121 of the insulating coil 20 protruding from the both sides of the mold body 30, respectively, is all covered by the external electrodes 40, when the complete inductor is seen from the outside, the core 10 and the insulating coil 20 are absolutely not shown, only the mold body 30 and the external electrodes 40 are shown, and the metal core 121 does not protrude absolutely, thereby providing high reliability.

In addition, the external electrodes 40 are formed on the both sides of the mold body 30 to be symmetrical. Compared with a case in which the external electrodes 40 are formed on the top and bottom, since a lead-bloating phenomenon more occurs upwards during reflow soldering, soldering strength is better.

Hereinafter, a method of manufacturing the SMD inductor according to one or more embodiments of the present invention will be described with reference to FIGS. 2 to 4.

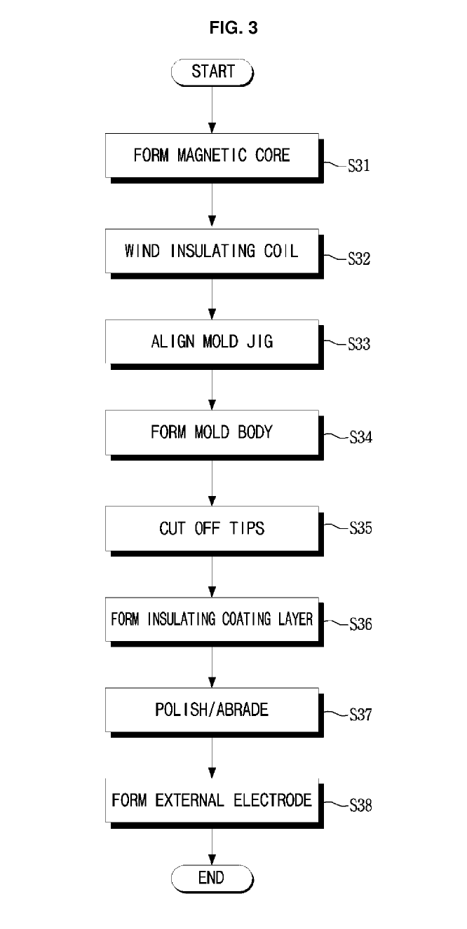

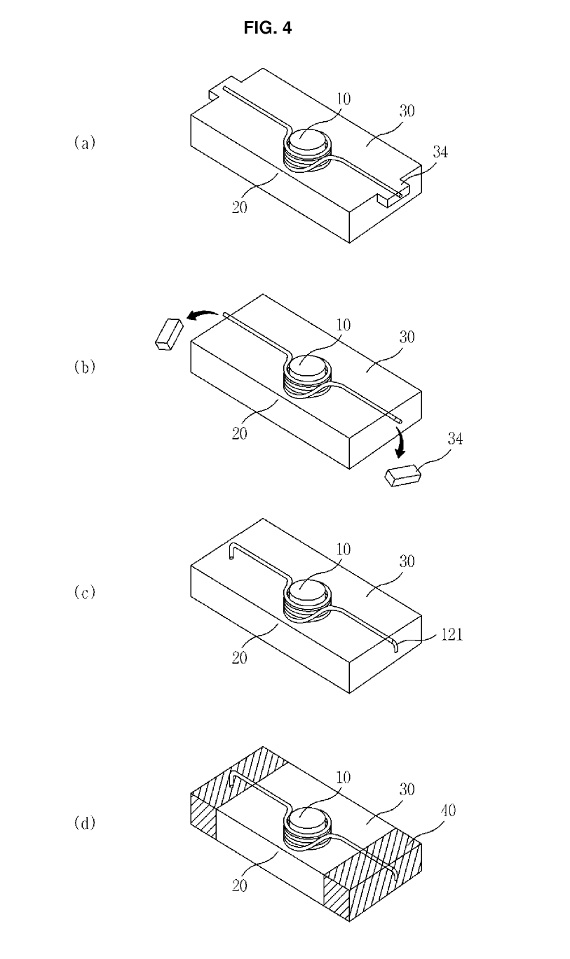

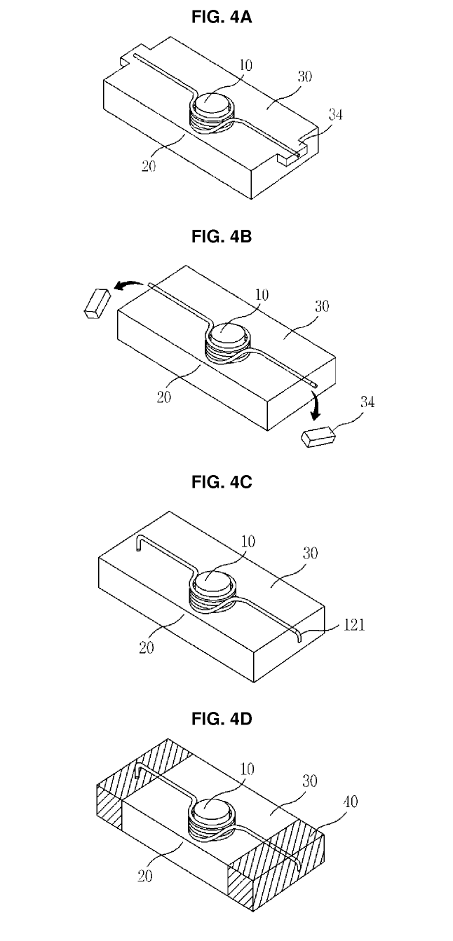

FIG. 3 is a flowchart illustrating the method of manufacturing the SMD type inductor according to one or more embodiments of the present invention, and FIGS. 4(A) to 4(D) illustrate a manufacturing process.

The core 10 is formed by compacting powder (S31).

In detail, soft magnetic metal powder applied with epoxy resin silicone rubber is inserted into a mold and compacted and then thermally cured at a temperature of about 160° C., thereby manufacturing the core 10. Otherwise, ferrite powder is inserted into a mold and pressed and then burned at a temperature of 900° C., thereby forming the core 10.

Optionally, the insulating coating layer 12 may be formed on the outer surface of the core 10. For example, parylene may be vapor-deposited using a vapor-deposition method. That is, a certain amount of the core 10 is put into a barrel and the barrel is rotated while vapor-phase parylene is being inserted into the barrel, thereby stirring the core 10 to be uniformly coated. Differently, in case of glass, the insulating coating layer 12 may be formed through dipping.

While winding the insulating coil 20 on the core 10 (S32), both ends of the insulating coil 20 are extended from the core 10 to be a little bit long to protrude from the outside of the mold body 30 with a certain length.

The core 10 wound with the insulating coil 20 is put into a mold jig and aligned (S33).

The mold jig is formed with a cavity having a shape corresponding to the mold body 30. The cavity may include a space to form tips 34 enclosing the both ends of the insulating coil 20 protruding from the outside of the mold body 30 with the certain length.

Sequentially, soft magnetic metal powder applied with epoxy resin or silicone rubber is inserted into the cavity of the mold jig and compacted, thereby forming the mold body 30 (S34). After the compacting, optionally, the mold body 30 may be thermally cured at a temperature of about 160° C. for an hour.

As a result thereof, as shown in FIG. 4(A), the tips 34 protrude from both sides of the mold body 30 and the both ends of the insulating coil 20 are embedded in the tips 34, respectively.

As shown in FIG. 4(B), the protruding tips 34 are cut (S35). Accordingly, the tips 34 are cut out of the mold body 30, thereby allowing the insulating coil 20 to protrude from the both sides of the mold body 30.

As described above, since the tips 34 may be formed optionally, the cutting (S35) may be omitted.

After that, optionally, heat-resistant polymer resin is applied to an outer surface of the mold body 30, thereby forming the insulating coating layer 32 (S36).

As shown in FIG. 4(C), the insulating coil 20 protruding from the sides of the mold body 30 is polished or abraded to remove the insulating coating 22 of the insulating coil 20, thereby exposing the metal core 121 (S37).

That is, when the insulating coating layer 32 is not formed, the mold body 30 may be polished using a ball-mill. When the insulating coating layer 32 is formed, the both sides of the mold body 30 may be abraded using an abrasive roll.

Herein, the insulating coating 22 of the insulating coil 20 is removed by polishing or abrading, thereby exposing the metal core 121. In other words, the metal core 121 is bent by polishing or abrading due to ductile deformation and closely attached to the sides of the mold body 30. Herein, polishing or abrasion is performed in such a way that the mold body 30 becomes a supporter and the insulating coating 22 not closely attached to the mold body 300 is removed by polishing or abrasion to expose the metal core 121.

During a process of polishing or abrasion, the metal core 121 may be elongated or compressed due to ductile deformation such as elongation. In this case, a surface area of the metal core 121 may further increase.

As a result thereof, an area of the metal core 121 in contact with the external electrode 40 increases, thereby reducing electric contact resistance and improving reliability of electric contact.

In one of the polishing and abrasion (S37), a part of the insulating coating layer 32 formed on the sides of the mold body 30 may be reduced, thereby reducing a thickness thereof.

In the embodiment, polishing or abrasion is performed for example but not limited thereto. The insulating coating 22 may be removed by burning or chemically treating protruding parts of the insulating coil 20. In this case, to remove the residual insulating coating 22, the residual insulating coating 22 and the residual insulating coating layer 32, or impurities and to allow the metal core 121 to be ductilely deformed to be closely attached to the mold body 30, a polishing or abrasion process may be performed.

Sequentially, as shown in FIG. 4(D), the sides including the protruding metal core 121 are applied with heat-resistant electroconductive epoxy resin through dipping and thermally cured at a temperature of about 250° C., thereby forming the external electrodes 40 (S38).

Additionally, the external electrodes 40 may be sequentially plated with nickel or tin to allow reflow soldering using solder cream to be easily performed.

As a result thereof, the external electrodes 40 are in electric contact with the insulating coil 20 with reliability over a larger area due to the metal core 121 protruding to be exposed and ductilely deformed, thereby reducing the contact resistance.

According to the SMD type inductor manufactured as described above, since the external electrode may be in electric contact with a larger area due to the ends of the insulating coil protruding from the mold body and ductilely deformed, electric contact resistance may decrease and electric contact with reliability may be provided.

Also, when a ferrite sintered body having high magnetic permeability is used as the core, a high inductance value of an inductor may be easily provided. Also, since a coil having a greater diameter is used, a higher current may be allowed to flow with the same inductance.

Also the insulating coating layer is formed on the outer surface of the semiconductive core and the outer surface of the mold body, thereby preventing currents flowing through the insulating coil from leaking out of the outer surface mold due to damages of the insulating coil.

Also, since the insulating coating layer is formed on the outer surface of the semiconductive mold body, a spreading phenomenon occurring in plating for forming the external electrode may be prevented and the mold body may not leak currents, thereby preventing the deterioration in quality of the inductor caused by a leaking current.

On the other hand, according to the manufacturing method, the SMD type inductor reducing electric contact resistance between the metal core of the insulating coil and the external electrode may be efficiently manufactured.

As described above, according to the one or more of the above embodiments of the present invention, As described above, according to the one or more of the above embodiments of the present invention, ends of an insulating coil protruding outwards from a mold body may be ductilely deformed using physical force, thereby exposing a metal core. Accordingly, since a surface area of the metal core in actually electric contact with the external electrode may be increased by adjusting a length of the protruding end of the insulating coil, electric contact resistance between the metal core of the insulating coil and the external electrode may decrease and reliable electric contact may be provided.

Also, a ferrite sintered body having high magnetic permeability may be used as an internal core, thereby increasing an inductance value of an inductor and allowing a high current to flow.

Also, an insulating coating layer may be formed on an outer surface of an external mold body, thereby easily plating while preventing a leaking current.

Also, an SMD type inductor reducing electric contact resistance between a metal core of an insulating coil and an external electrode and having reliable electric contact may be economically and efficiently manufactured.

While one or more embodiments of the present invention have been described with reference to the figures, it will be understood by those of ordinary skill in the art that various changes in form and details may be made therein without departing from the spirit and scope of the present invention as defined by the following claims.

What is claimed is:

1. A surface-mount device (SMD) type inductor comprising:
a core formed of magnetic material;
an insulating coil wound on an outer surface of the core;
a mold body containing the core and the insulating coil to be embedded therein, ends of the insulating coil protruding respectively from both sides of the mold body, which are opposite to each other, the mold body formed of soft magnetic metal compact using soft magnetic metal powder; and
external electrodes formed on the both sides of the mold body and electrically connected to a metal core of the protruding ends of the insulating coil,
wherein the protruding ends of the insulating coil are partially removed by physical force to expose the metal core and the external electrodes are electrically connected to the exposed metal core.

2. The SMD type inductor of claim 1, wherein the core comprises one of a ferrite sintered body formed by pressing and burning ferrite powder having magnetic properties and a soft magnetic metal compact formed by compacting and thermally curing soft magnetic metal powder having magnetic properties.

3. The SMD type inductor of claim 2, wherein the ferrite powder and the soft magnetic metal powder are coated or comprise heat-resistant polymer resin.

4. The SMD type inductor of claim 1, wherein the insulating coil is formed by coating the metal core with insulating polymer resin having thermal resistance, and
wherein the insulating polymer resin is removed by the physical force, thereby exposing the metal core.

5. The SMD type inductor of claim 1, wherein the external electrodes are formed by curing electroconductive epoxy paste adhesives and the electroconductive epoxy paste adhesives are sequentially coated with nickel and tin thereon.

6. The SMD type inductor of claim 1, wherein a heat-resistant insulating coating layer is formed on an outer surface of the mold body.

7. The SMD type inductor of claim 6, wherein the heat-resistant insulating coating layer comprises one of glass and heat-resistant polymer resin.

8. The SMD type inductor of claim 1, wherein the physical force is one of polishing and abrasion, which closely attaches the ends of the insulating coil to the mold body and bents, elongates, and compress the metal core to be ductilely deformed.

9. The SMD type inductor of claim 1, wherein the metal core is exposed as much as the protruding ends of the insulating coil due to the physical fore and a contact area with the external electrode increases, thereby reducing electric contact resistance of the metal core and increasing the reliability of electric contact.

10. The SMD type inductor of claim 1, wherein the mold body is thermally cured and the mechanical strength of the mold body increases due to the thermal curing.

11. The SMD type inductor of claim 1, wherein the inductor is a power inductor.

12. A method of manufacturing an SMD type inductor, the method comprising:
forming a core by pressing powder of magnetic material;
burning or thermally curing the core;
winding an insulating coil on an outer surface of the core;
forming a mold body by putting the core wound with the insulating coil into a mold jig and applying soft magnetic metal powder thereto to embed the insulating coil and the core therein and to allow ends of the insulating coil to protrude;
polishing or abrading the mold body; and
forming external electrodes on sides of the mold body, which are opposite to each other, to be electrically connected to a metal core of the ends of the insulating coil,
wherein the ends of the insulating coil are partially removed by one of the polishing and abrading to expose the metal core of the ends of the insulating coil and the external electrodes are electrically connected to the exposed metal core.

13. The method of claim 12, wherein tips, in which the ends of the insulating coil are embedded, protrude from the sides of the mold body, and
wherein the tips are cut off from the mold body, thereby allowing the ends of the insulating coil to protrude.

14. The method of claim 12, wherein an outer surface of the mold body is polished using a ball-mill or abraded using an abrasive roll.

15. The method of claim 12, wherein the insulating coil comprises insulating polymer resin coating the metal core, the insulating polymer resin is removed from the ends of the insulating coil by one of the polishing and abrading to expose the metal core.

16. The method of claim 12, wherein the ends of the insulating coil are closely attached to the mold body and the metal core is bent, elongated, or compressed to be ductilely deformed, by one of the polishing and abrading.

17. The method of claim 12, further comprising thermally curing the mold body,
wherein the mold body increases in mechanical strength due to the curing.

18. The method of claim 12, further comprising, after the forming the mold body, forming an insulating coating layer on the outer surface of the mold body.

19. The method of claim 12, wherein the mold body is formed by one of compacting soft magnetic metal powder coated with polymer resin, potting liquid polymer resin comprising soft magnetic metal powder, and injection-molding pellets comprising soft magnetic metal powder.
